(19) United States
(12) Patent Application Publication
(10) Pub. No.: US 2024/0217812 A1
(43) Pub. Date: Jul. 4, 2024

(54) HYDROGEN RELEASE SYSTEMS

(71) Applicant: Electriq-Global Energy Solutions Ltd., Tirat Carmel (IL)

(72) Inventors: Baruch HALPERT, Caesarea (IL); Erez KARASENTI, Haifa (IL)

(21) Appl. No.: 18/557,116

(22) PCT Filed: Apr. 25, 2022
(86) PCT No.: PCT/IL2022/050420

§ 371 Date: Oct. 25, 2023

Related U.S. Application Data
(60) Provisional application No. 63/180,254, filed on Apr. 27, 2021.

(51) Int. Cl. C01B 3/06

(52) U.S. Cl. CPC C01B 3/065; C01B 2203/066; C01B 2203/0827

(57) ABSTRACT

A system for releasing Hydrogen gas from a Hydrogen liquid carrier is described. The system may be used to provide hydrogen gas for a respective fuel cell. The system comprises a water recycling module placed in fluid communication with the fuel cell and with a hydrogen liquid carrier assembly and being configured and operable to capture water released from the fuel cell and convey the captured water to the hydrogen liquid carrier assembly for use in producing the Hydrogen liquid carrier. The captures water may be in liquid or gas phase.

### TECHNOLOGICAL FIELD

The present invention is in the field of energy sources, specifically hydrogen gas release systems for use in fuel cells. In particular, the present invention relates to modules for managing resources used in hydrogen gas release systems that utilize a hydrogen liquid carrier as a source of the hydrogen gas.

### BACKGROUND

With the limited supply of fossil fuels and their adverse effect on the climate and the environment, it has become a global priority to seek alternate sources of energy that are clean, abundant, and sustainable.

Hydrogen has become an increasingly attractive source for clean energy production in recent years. Hydrogen, which has the highest energy per mass of any fuel, may provide a highly efficient zero-emission energy source. In particular, mobility devices, such as cars, bicycles or aircrafts can benefit from Hydrogen as an energy source.

At ambient conditions, hydrogen is a volatile gas. One kg of hydrogen occupies 11.2 m³ (˜100 g/m³)—a volume that may be impractically large for certain hydrogen-based energy applications. One goal in hydrogen utilization, therefore, is the reduction of hydrogen volume, either by compression, liquefaction, adsorption to high surface area materials, or embedding in solid compounds. Other challenges from the materials perspective may include combined volumetric and gravimetric hydrogen density that may be required for use in the transportation industry (e.g., 5.5 mass % H₂ and 40 kgH₂/m³, respectively), suitable thermodynamic stability for the working temperature (e.g., −40 to) 200° ° C., and sufficiently fast reaction kinetics to allow rapid hydrogen uptake and delivery (e.g., refueling of 5 kg of H₂ in few minutes). Several systems for hydrogen release from a Hydrogen liquid carrier are described for example in WO2016/139669, WO 2019/202381, WO 2019/202382, WO 2019/202391 and WO 2020/008251, all assigned to the assignee of the present patent application.

### GENERAL DESCRIPTION

The present invention provides novel techniques for effective and efficient management of resources that are utilized by hydrogen release systems that release hydrogen from a hydrogen liquid carrier.

In particular, the present invention provides compact, yet powerful and efficient, hydrogen release systems by saving on weight and volume of essential system components. In addition, the disclosed systems are energy efficient and save on energy resources, such as heat, required in the release of the hydrogen from a hydrogen liquid carrier.

Hydrogen release systems are employed in various applications such as industrial facilities and mobility devices, e.g. cars. Mobility devices are limited in their space, and are desired to have as low as possible weight to save on energy consumption.

The present invention enables lowering the weight and volume of the system by providing a closed-loop of recycled water that is required in the preparation of the Hydrogen liquid carrier on-board. This is especially advantageous in mobility devices. Waste water is an outcome of the electricity generation reaction that takes place in the fuel cell. This waste water is generally thrown away. The present invention provides a closed-loop by using the waste water in the preparation of the Hydrogen liquid carrier.

Further, the present invention enables lowering the energy supply demand by providing a closed-loop of recycled heat that is required to activate the chemical reaction of the Hydrogen release from the Hydrogen liquid carrier. The process for hydrogen release involves an initiation step of heating the hydrogen liquid carrier (HLC) up to 50° C. Accordingly, a continuous supply of thermal energy is needed. On the other side, the Hydrogen release reaction is exothermic. The generated heat is typically not used and there is a need to dissipate it. The present invention enables utilizing the heat produced in the Hydrogen release reaction in order to heat the hydrogen liquid carrier to the required level in order to initiate the Hydrogen release reaction. By this, the invention enables increasing the system efficiency by at least 15% in comparison to known systems that use new energy each time to heat the Hydrogen liquid carrier.

Thus, according to a first broad aspect of the present invention, there is provided a system for releasing Hydrogen gas from a Hydrogen liquid carrier for use with a fuel cell, the system comprising a water recycling module being in fluid communication with the fuel cell and with a hydrogen liquid carrier assembly and being configured and operable to capture water being in at least one of gas or liquid phases from the fuel cell and convey the captured water to the hydrogen liquid carrier assembly for use in producing the Hydrogen liquid carrier.

In some embodiments, the water recycling module comprises a pump configured to controllably pull the water from the fuel cell.

In some embodiments, the water recycling module comprises a condenser configured to transform the water in the gas phase into the liquid phase before conveying the water to the Hydrogen liquid carrier assembly.

In some embodiments, the hydrogen liquid carrier assembly comprises at least one of a liquid tank and a mixing chamber being configured for receiving the water from the water recycling module to thereby produce the Hydrogen liquid carrier in the mixing chamber. According to another broad aspect of the present invention, there is provided a system for releasing Hydrogen gas from a Hydrogen liquid carrier for use with a fuel cell, the system comprising a heat recycling module configured and operable to controllably exchange heat with the Hydrogen liquid carrier by capturing heat resulting from a first hydrogen gas release reaction of a first portion of the hydrogen liquid carrier taking place during a first time period in a reaction chamber and releasing the captured heat to a second portion of the hydrogen liquid carrier entering the reaction chamber during a second time period in order to initiate a second hydrogen gas release reaction of the second portion of the hydrogen liquid carrier in the reaction chamber.

In some embodiments, the heat recycling module is located inside the reaction chamber.

In some embodiments, the heat recycling module is adapted for working in an alkaline environment. The heat recycling module may comprise a coating selected from one or more of the following: Chrome, Nickel and Teflon.

In some embodiments, the heat recycling module is made from at least one material comprising a metal or an alloy thereof. The metal may be selected from one of the following: Copper, Aluminum, and Stainless Steel.

In some embodiments, the heat recycling module has predetermined shape and weight adapted to at least one of the following: properties of the first and second portions of the hydrogen liquid carrier, and time duration of said first and second hydrogen gas release reactions. The properties of the first and second portions of the hydrogen liquid carrier comprise one or more of the following: pH, volume, heat capacity, heat flux transition, and reaction working temperature.

In some embodiments, the heat recycling module is configured to change at least one of its active surface area or three-dimensional position with respect to the hydrogen liquid carrier during the first and/or second hydrogen gas release reactions to thereby controllably exchange the heat with the first and second portions of the hydrogen liquid carrier respectively.

In some embodiments, the systems above further comprise an on-board hydrogen liquid carrier producing system configured and operable to provide said hydrogen liquid carrier.

The on-board hydrogen liquid carrier producing system may comprise:
a liquid tank configured for storing a liquid,
a solid reservoir configured for storing a solid composition comprising at least one Metal Borohydride,
a mixing chamber configured to receive said liquid and solid composition from said liquid and solid tanks, controllably mix the liquid and solid composition and produce said hydrogen liquid carrier, and
at least one conveyor device module configured to control rate of transfer of the liquid and solid compositions into said mixing chamber.

In some embodiments, the mixing chamber comprises a Hydrogen outlet in communication with a Hydrogen gas tank for transferring Hydrogen gas generated in the mixing chamber during the mixing of the liquid and solid composition.

In some embodiments, the solid reservoir comprises one or more of the following: an integral refillable tank and a disposable package.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates, by way of a block diagram, a non-limiting example of a system for releasing hydrogen gas, including a water recycling module in accordance with embodiments of the present invention;

FIG. 2 illustrates one non-limiting example of the water recycling module of the present invention;

FIG. 3 illustrates, by way of a block diagram, a non-limiting example of a system for releasing hydrogen gas, including a heat recycling module in accordance with embodiments of the present invention;

FIG. 4 illustrates one non-limiting example of the heat recycling module of the present invention; and

FIG. 5 illustrates another non-limiting example of the heat recycling module of the present invention, combined with a catalyst module, in accordance with embodiments of the present invention.

### DETAILED DESCRIPTION OF EMBODIMENTS

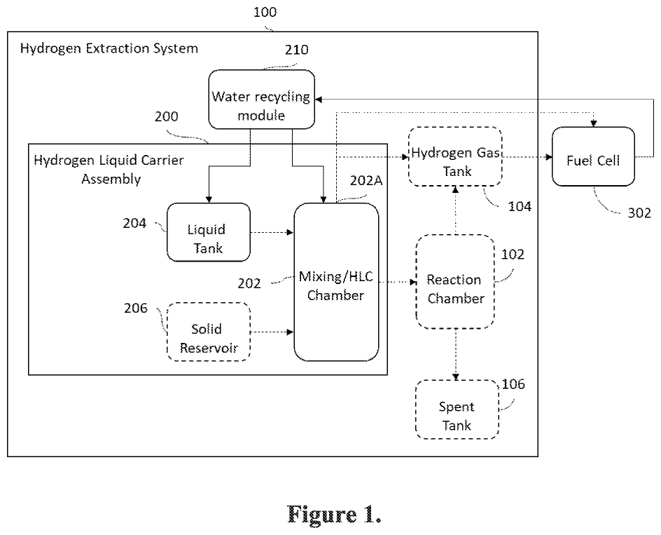

Reference is made to FIG. 1 illustrating by way of a block diagram a non-limiting example of a first aspect, in accordance with non-limiting embodiments of the present invention. As shown, a system 100 for releasing Hydrogen gas from a Hydrogen liquid carrier (HLC) for use in a fuel cell 302 is provided. The system 100 includes a water recycling module 210 being in fluid communication with the fuel cell 302 and with a hydrogen liquid carrier assembly 200 and being configured and operable to capture water being in at least one of gas or liquid phases from the fuel cell 302 and convey the captured water to the hydrogen liquid carrier assembly 200 for use in producing the Hydrogen liquid carrier HLC.

It should be understood, that the boxes which are illustrated in dashed lines describe different components that are basically found in Hydrogen release systems. These components do not form essential components of the present aspect of the invention and are included in the block diagram for the sake of clarity and completeness.

As mentioned above, in a hydrogen release system, that utilizes on-board preparation of the base material from which the hydrogen is extracted in a chemical reaction, in which a liquid carrying the hydrogen (HLC) is the base material, there is a continuous need for water supply that is mixed with a metal borohydride, such as sodium borohydride and potassium borohydride, in order to produce the hydrogen carrier liquid HLC. In certain applications, such as in mobility devices, the water supply is limited due to, for example, constraints on usable space and weight of the vehicle.

The electricity producing reaction that takes place in the fuel cell results in by-products that are not needed for the occurring reaction. One of the by-products is water. Usually, when the water supply is basically unlimited, the water by-product is typically dismissed by the provision of a water outlet in the fuel cell. The water resulting from the electricity producing reaction can be in one of two phases, either a liquid at the start of the electricity producing reaction when the temperature inside the fuel cell is relatively low, or a gas at a later stage when the temperature inside the fuel cell increases to high levels.

According to the present invention, in hydrogen release systems that include on-board preparation of the hydrogen liquid carrier and which are limited in water supply, due to space and/or weight considerations, such as in vehicles, recycling the by-product water is advantageous.

In the figure, the water recycling module 210 obtains the water from the fuel cell 302 in either the gaseous or liquid phase, via a dedicated water outlet, and transfer it to the hydrogen liquid carrier assembly 200, in particular to at least one of a liquid tank 204 configured for storing the water or a mixing chamber 202 where the water is mixed with a suitable solid to produce the hydrogen liquid carrier. Recycling the water from the fuel cell enables optimizing the volume and weight of at least one of the liquid tank 204 and mixing chamber 202. For example, in vehicles it is possible to carry a liquid tank of a reduced volume and weight, specifically 30% less volume than in the case when no water recycling is taking place.

The hydrogen release system 100 also includes a reaction chamber 102 to which the hydrogen liquid carrier is entered where a chemical reaction occurs, possibly using a catalyst, as will be further described below, and hydrogen gas is extracted and transferred from the mixing chamber 102 to a hydrogen gas tank 104 that stores the hydrogen gas and which is then controllably released into the fuel cell for generating electricity.

The remaining quantity of the hydrogen liquid carrier in the reaction chamber 102 which is also called spent, is removed from the reaction chamber into a spent tank 106, to allow for a new portion of the hydrogen liquid carrier to enter the reaction chamber 102 from the mixing chamber 202.

A solid reservoir 206 can be also provided in the hydrogen release system 100 and particularly as part of the hydrogen liquid carrier assembly 200. The solid reservoir 206 is adapted to store a certain solid, in one of various forms, which upon controllably mixing with water from the liquid tank 204 or directly in the mixing chamber 202 the hydrogen carrier liquid is created. In some embodiments, the solid reservoir 206 is an integral refillable tank. Alternatively or additionally, the solid reservoir 206 is a disposable package, i.e. a cartridge that is for one time usage and that gets replaced once empty.

In some embodiments, the solid reservoir 206 can be adapted to store at least one of the following material forms: powder concentrated carrier and semisolid. The chosen form(s) may depend on various parameters and specifications of the material, such as solubility and/or density.

In some embodiments, as shown in the figure, the mixing chamber 202 includes a Hydrogen outlet 202A that is in fluid communication with the Hydrogen gas tank 104 for transferring Hydrogen gas generated in the mixing chamber 202 during the mixing of the liquid and solid composition. This hydrogen gas generation occurs due to spontaneous release activity that takes place when certain conditions, such as temperature, occur inside the mixing chamber 202, without the need for a catalyst that is required for massive Hydrogen gas release that takes place in the reaction chamber 102. Additionally or alternatively, as shown, the mixing chamber can be in direct fluid communication with the fuel cell to directly transfer the spontaneously released hydrogen to the fuel cell.

Suitable connecting tubes and connectors can be used to connect the water recycling module 210 to the water outlet at the fuel cell 302 and to water inlet(s) at the hydrogen liquid carrier assembly 200, such as at the liquid tank 204 or the mixing chamber 202 or both.

In some embodiments, the system 100 includes, possibly as part of the hydrogen liquid carrier assembly 200, at least one conveyor module (not specifically shown) connected between the liquid tank 204 and solid reservoir 206 and the mixing chamber 202, and being configured to control rate of transfer of the liquid and solid compositions, from the liquid tank 204 and solid reservoir 206, into the mixing chamber 202.

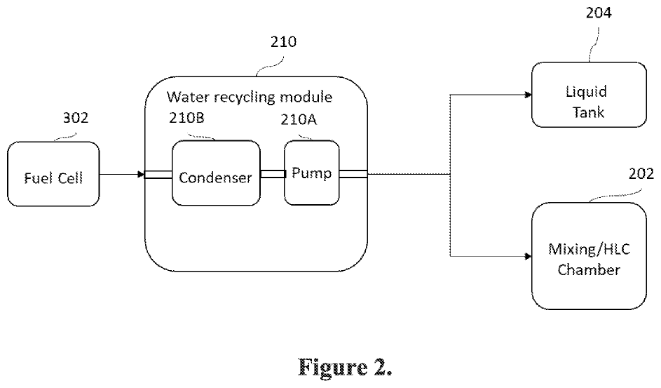

Reference is made to FIG. 2 illustrating a non-limiting example of the water recycling module 210, in accordance with some embodiments of the present invention.

As shown, the water recycling module 210 may include a pump 210A adapted to efficiently acquire the by-product water, that is generated in the fuel cell 302, at a predetermined rate being adjusted to various parameters of the system, such as the water production rate at the fuel cell, the volume of liquid tank, and others.

The water recycling module 210 may include a condenser 210B, located before the pump, adapted to transform the water in the gas phase into the liquid phase before conveying the water to the Hydrogen liquid carrier assembly.

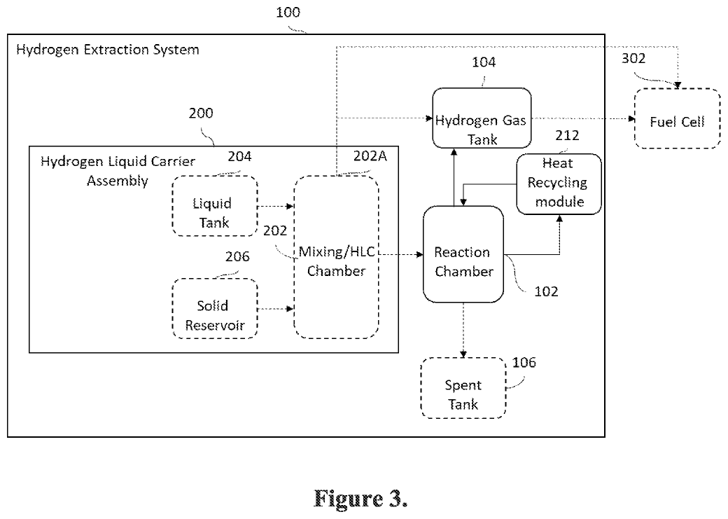

The condenser starts to act once the temperature inside the fuel cell increases and the by-produce water is in a fluid phase (gas and water together) or totally in a gaseous phase. Reference is now made to FIG. 3 illustrating by way of a block diagram a non-limiting example of a second aspect of the hydrogen gas release system 100, in accordance with non-limiting embodiments of the present invention. As shown, the system 100 includes a heat recycling module 212 configured and operable to controllably exchange heat with the Hydrogen liquid carrier by capturing heat resulting from a first hydrogen gas release reaction of a first portion of the hydrogen liquid carrier taking place during a first time period in the reaction chamber 102 and releasing the captured heat to a second portion of the hydrogen liquid carrier entering the reaction chamber 102 during a second time period in order to initiate a second hydrogen gas release reaction of the second portion of the hydrogen liquid carrier in the reaction chamber 102.

It should be understood that, the reaction of hydrogen gas release from the hydrogen liquid carrier is exothermic but requires energy in the form of activation heat in order to occur. Typically, such hydrogen release systems, that extract hydrogen from a hydrogen liquid carrier, include a heat generator configured to heat the hydrogen liquid carrier up to a specific temperature in order to initiate the hydrogen gas release. For example, if the hydrogen liquid carrier is potassium borohydride, the required temperature is at least 40 degrees Celsius. The heat generator is energy consuming, all depending on the amount of the hydrogen gas to be extracted. On the other side, once the hydrogen gas is extracted, a release of heat occurs, i.e. the hydrogen gas release reaction is exothermic. Typically, the released heat is actively dissipated by a cooling system that is responsible for cooling the reaction chamber 102 during the release reaction.

According to the present invention, a considerable energy saving is achieved by the fact that the heat generator is used only for heating the first portion of the hydrogen liquid carrier while for all the rest portions the heat which results from the hydrogen release reaction is stored and then released, i.e. recycled, in order to heat the next portion of the hydrogen liquid carrier. The first portion of the hydrogen liquid carrier, or at least the liquid component thereof, is possibly heated in any one of the following locations: the liquid tank 204, the mixing chamber 202 or the reaction chamber 102.

In some embodiments, the heat recycling module 212 is positioned inside the reaction chamber 102 and comes into contact with a first portion of the hydrogen liquid carrier, during the hydrogen release reaction, to thereby collect heat generated during the ongoing first reaction. As appreciated, the first portion of the hydrogen liquid carrier has already been heated by the energy-consuming heat generator. Then, when the spent is transferred to the spent tank 106 and a new second portion of the hydrogen liquid carrier enters the reaction chamber 102 from the mixing chamber 202, the heat recycling module 212 releases the heat to the second portion of the hydrogen liquid carrier thereby activating and initiating the hydrogen release reaction in the second portion. Once the exothermic release reaction takes place in the second portion, the generated heat is stored in the heat recycling module 212 for use with a third portion of the hydrogen liquid carrier, and so on.

In some embodiments, the heat recycling module 212 is configured as a heat battery that is continuously charged and discharged.

The heat recycling module 212 can be made of any suitable material capable of exchanging heat with a nearby medium. The chosen material is one that has charging and discharging times meeting the system requirements. In some embodiments, the heat recycling module 212 is made from a single material.

In some embodiments, the heat recycling module 212 is made from a plurality of materials. In some embodiments, the heat recycling module 212 is made from a material or a combination of materials adapted for alkaline environment.

In some embodiments, the heat recycling module 212 is made from at least one inner material and at least one outer material coating/enveloping the at least one inner material. In some embodiments, the inner material is selected to meet the heat charging and discharging characteristics and the outer material is selected to withstand the alkaline environment.

In some embodiments, the single/inner material is a metal or an alloy selected from one or more of the following: Copper, Aluminum, Stainless Steel (e.g., SS 316 L).

In some embodiments, the outer material is selected from one or more of the following: Chrome, Nickel, Teflon.

The heat recycling module 212 has predetermined shape (specifically, surface area that is adapted to interact with the hydrogen liquid carrier), and weight, both adapted to meet the required heat exchange (both charging and discharging) requirements, such as the heat exchange rates. In some embodiments, the shape and/or weight are determined based on at least one of the following: 1) properties of the first and second portions of the hydrogen liquid carrier, such as constituents, pH, volume, heat capacity, heat flux transition reaction working temperature; 2) time duration of the first and second hydrogen gas release reactions.

In some embodiments, the heat recycling module 212 is configured to change its three-dimensional position with respect to the hydrogen liquid carrier during the first and/or second hydrogen gas release reactions to thereby control the heat exchange parameters with the first and second portions of the hydrogen liquid carrier respectively. By this, the heat recycling module 212 may adjust to different heat charging and discharging rates, e.g. a faster charging rate and a slower discharging rate, or a variable charging/discharging rate(s), in order to meet the on-line system requirements. The three-dimensional position change may include changing the momentary surface area interacting with the surrounding medium (in this case, the hydrogen liquid carrier). Further details are mentioned below.

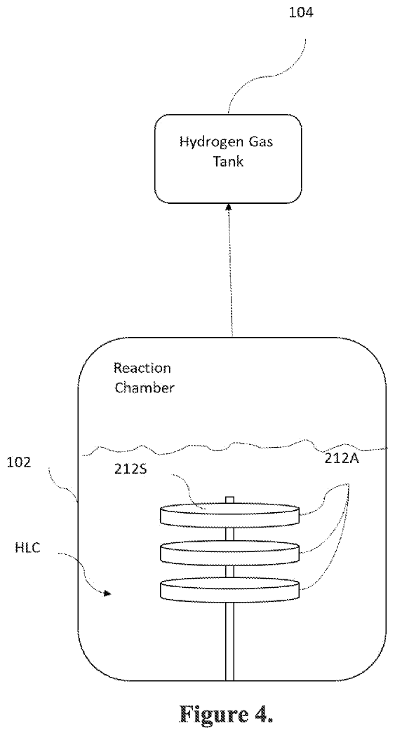

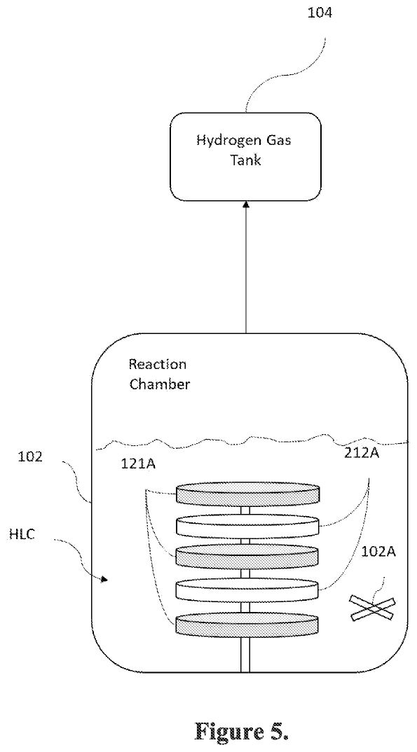

Reference is now made to FIGS. 4 and 5 illustrating different non-limiting examples of the heat recycling module 212 located inside the reaction chamber 102.

The heat recycling module 212 may include one or more heat recycling elements positioned at different locations inside the reaction chamber 102.

In FIG. 4, a plurality of heat recycling elements 212A, namely three in this non-limiting example, are positioned spaced-apart a long an axis of the reaction chamber 102. The heat recycling elements are configured to contact the hydrogen liquid carrier. Each heat recycling element 212A has a surface area 212S that comes in contact with the surrounding hydrogen liquid carrier. The surface area 212S can be typically from different sides of the heat recycling element, and the illustration showing the upper side in the figure should not be limiting. By controlling the number and shape of the heat recycling elements 212A, the overall surface area of the heat recycling module 212 that interacts with the hydrogen liquid carrier is determined.

The reaction chamber 102 may also include a catalyst module for facilitating the hydrogen gas release reaction. Examples for the catalyst module are described, for example, in WO2019202391 assigned to the assignee of the present invention. The heat recycling module and the catalyst module may be located inside the reaction chamber in a configuration that maximizes the hydrogen gas release reaction. In the non-limiting example of FIG. 5, a heat recycling module 212A is positioned between two catalyst elements 121A, the heat recycling element 212A exchanges heat with the hydrogen liquid carrier (transfers heat to/from the hydrogen liquid carrier, as the case may be) on both of its upper and bottom sides adjacent the two catalyst elements above and below. The ratio of the numbers of the heat recycling elements and catalyst elements can be adjusted subject to the requirements of the system.

The reaction chamber 102 may include one or more flow controllers configured to cause a controlled relative flow of the hydrogen liquid carrier with respect to the heat recycling/catalyst modules (at least specific elements thereof) inside the reaction chamber. Such a flow controller 102A is illustrated in the figure. Additionally or alternatively, the heat recycling/catalyst modules (at least specific elements thereof) can be configured to move inside the reaction chamber with respect to the hydrogen liquid carrier. In one specific embodiment, at least some of the heat recycling/catalyst elements may be mounted on a moving base, e.g. a rotatable base, to thereby cause a relative movement between the heat recycling/catalyst modules and the hydrogen liquid carrier and affect the hydrogen release reaction process/rate. In some embodiments, the relative movement controls the amount or surface area of the heat recycling/catalyst elements that interacts with the hydrogen liquid carrier. For example, at least a portion of the heat recycling/catalyst elements is immersed in the hydrogen liquid carrier and the other portion is located outside the hydrogen liquid carrier.

It is well appreciated that the hydrogen release system may include both of the water recycling and heat recycling modules, though this configuration is not specifically illustrated in a single figure.

1. A system for releasing Hydrogen gas from a Hydrogen liquid carrier for use with a fuel cell, the system comprising:
a water recycling module being in fluid communication with the fuel cell and with a hydrogen liquid carrier assembly and being configured and operable to capture water being in at least one of gas or liquid phases from the fuel cell and convey the captured water to the hydrogen liquid carrier assembly for use in producing the Hydrogen liquid carrier.

2. The system according to claim 1, wherein said water recycling module comprises a pump configured to controllably pull the water from the fuel cell.

3. The system according to claim 1, wherein said water recycling module comprises a condenser configured to transform the water in the gas phase into the liquid phase before conveying the water to the Hydrogen liquid carrier assembly.

4. The system according to claim 1, wherein said hydrogen liquid carrier assembly comprises at least one of a liquid tank and a mixing chamber being configured for receiving the water from the water recycling module to thereby produce the Hydrogen liquid carrier in the mixing chamber.

5. The system according to claim 4, comprising an on-board hydrogen liquid carrier producing system comprising:
said liquid tank being configured for storing the water,
a solid reservoir configured for storing a solid composition comprising at least one type of Metal Borohydride,
said mixing chamber being configured to receive said liquid and solid composition from said liquid and solid tanks, controllably mix the liquid and solid composition and produce said hydrogen liquid carrier, and
at least one conveyor module configured to control rate of transfer of the liquid and solid compositions into said mixing chamber.

6. The system according to claim 5, wherein said mixing chamber comprises a Hydrogen outlet in communication with a Hydrogen gas tank for transferring Hydrogen gas generated in the mixing chamber during the mixing of the liquid and solid composition.

7. The system according to claim 5, wherein said solid reservoir comprises one or more of the following: an integral refillable tank and a disposable package.

8. A system for releasing Hydrogen gas from a Hydrogen liquid carrier for use with a fuel cell, the system comprising a heat recycling module configured and operable to controllably exchange heat with the Hydrogen liquid carrier by capturing heat resulting from a first hydrogen gas release reaction of a first portion of the hydrogen liquid carrier taking place during a first time period in a reaction chamber and releasing the captured heat to a second portion of the hydrogen liquid carrier entering the reaction chamber during a second time period in order to initiate a second hydrogen gas release reaction of the second portion of the hydrogen liquid carrier in the reaction chamber; wherein said heat recycling module is located inside the reaction chamber.

9. (canceled)

10. The system according to claim 8, wherein said heat recycling module is adapted for working in an alkaline environment.

11. The system according to claim 10, wherein said heat recycling module comprises a coating selected from one or more of the following: Chrome, Nickel and Teflon.

12. The system according to claim 8, wherein said heat recycling module is made from at least one material comprising a metal or an alloy thereof.

13. The system according to claim 12, wherein said metal is selected from the group consisting of: copper, aluminum, stainless steel.

14. The system according to claim 8, wherein said heat recycling module has predetermined shape and weight adapted to at least one of the following: properties of the first and second portions of the hydrogen liquid carrier, and time duration of said first and second hydrogen gas release reactions.

15. The system according to claim 14, wherein said properties of the first and second portions of the hydrogen liquid carrier comprise one or more of the following: pH, volume, heat capacity, heat flux transition, and reaction working temperature.

16. The system according to claim 8, wherein said heat recycling module is configured to change at least one of its active surface area or three-dimensional position with respect to the hydrogen liquid carrier during the first and/or second hydrogen gas release reactions to thereby controllably exchange the heat with the first and second portions of the hydrogen liquid carrier respectively.

17. The system according to claim 8, further comprising an on-board hydrogen liquid carrier producing system configured and operable to provide said hydrogen liquid carrier.

18. The system according to claim 17, wherein said on-board hydrogen liquid carrier producing system comprises:
a liquid tank configured for storing a liquid,
a solid reservoir configured for storing a solid composition comprising at least one type of Metal Borohydride,
a mixing chamber configured to receive said liquid and solid composition from said liquid and solid tanks, controllably mix the liquid and solid composition and produce said hydrogen liquid carrier, and
at least one conveyor module configured to control rate of transfer of the liquid and solid compositions into said mixing chamber.

19. The system according to claim 18, wherein said mixing chamber comprises a Hydrogen outlet in communication with a Hydrogen gas tank for transferring Hydrogen gas generated in the mixing chamber during the mixing of the liquid and solid composition.

20. The system according to claim 18, wherein said solid reservoir comprises one or more of the following: an integral refillable tank and ox a disposable package.

21. A system for releasing Hydrogen gas from a Hydrogen liquid carrier for use with a fuel cell, the system comprising:
a heat recycling module configured and operable to controllably exchange heat with the Hydrogen liquid carrier by capturing heat resulting from a first hydrogen gas release reaction of a first portion of the hydrogen liquid carrier taking place during a first time period in a reaction chamber and releasing the captured heat to a second portion of the hydrogen liquid carrier entering the reaction chamber during a second time period in order to initiate a second hydrogen gas release reaction of the second portion of the hydrogen liquid carrier in the reaction chamber,
wherein said heat recycling module is configured to change at least one of its active surface area or three-dimensional position with respect to the hydrogen liquid carrier during the first and/or second hydrogen gas release reactions to thereby controllably exchange the heat with the first and second portions of the hydrogen liquid carrier respectively.
